(19) United States
(12) Patent Application Publication
(10) Pub. No.: US 2006/0225350 A1
(43) Pub. Date: Oct. 12, 2006

(54) Systems and methods for controlling hydrogen generation

(76) Inventors: John Spallone, Danbury, CT (US); Richard M. Mohring, East Brunswick, NJ (US); Ian Eason, Hillsborough, NJ (US); Robert Molter, Somerset, NJ (US); Grant Berry, Hillsborough, NC (US); Keith A. Fennimore, Columbus, NJ (US)

Correspondence Address: DICKSTEIN SHAPIRO LLP, 1825 EYE STREET NW, Washington, DC, 20006-5403, US

(21) Appl. No.: 11/340,506

(22) Filed: Jan. 27, 2006

Related U.S. Application Data
(60) Provisional application No. 60/647,393, filed on Jan. 28, 2005.

(51) Int. Cl. C01B 3/24

(52) U.S. Cl. 48/198.2

(57) ABSTRACT

Systems and methods are disclosed for monitoring at least two system parameters (such as system temperature or pressure, or system pressure at two different locations) of a hydrogen generation system and controlling hydrogen generation from a fuel solution. The system comprises a hydrogen generator having a fuel chamber for a liquid fuel, a reactor chamber where the fuel undergoes a reaction to produce hydrogen, and at least two sensors in communication with the reactor chamber, the sensors measuring at least two system parameters of the hydrogen generator. The methods include control sequences for controlling the fuel flow rate to the reactor based on the sensed parameters.

This application claims the benefit of U.S. Provisional Application Ser. No. 60/647,393, filed Jan. 28, 2005, the entire disclosure of which is incorporated herein by reference.

### FIELD OF THE INVENTION

The invention relates to systems for generating hydrogen gas from reformable fuels and to methods for monitoring and controlling hydrogen generation.

### BACKGROUND OF THE INVENTION

Although hydrogen is the fuel of choice for fuel cells, its widespread use is complicated by the difficulties in storing the gas. Many hydrogen carriers, including hydrocarbons, metal hydrides, and chemical hydrides are being considered as hydrogen storage and supply systems. In each case, specific systems need to be developed in order to release the hydrogen from its carrier, either by reformation as in the case of hydrocarbons, desorption from metal hydrides, or catalyzed hydrolysis of chemical hydrides.

Various hydrogen generation systems have been developed for the production of hydrogen gas from fuel solutions. Such generators typically meter a fuel solution to contact a hydrogen generation catalyst to produce hydrogen as needed. It is important to control hydrogen generation and to match the system's hydrogen flow rate and pressure to the operating demands of the fuel cell.

### BRIEF SUMMARY OF THE INVENTION

The present invention provides systems and methods for monitoring at least one and preferably at least two system parameters (such as temperature or pressure within the system, or pressure at two different locations in the system) of a hydrogen generation system and/or controlling hydrogen generation from a fuel solution by regulating the flow rate of the fuel solution to the reactor. By “two system parameters” herein we also mean to include a single variable, such as pressure, measured at two different locations. Among the parameters that may be sensed and used in the control sequences herein are, for example, pressure, temperature, volume, flow rate, and concentration of species such as H₂, CO and CO₂ in the system. When a single parameter is detected, preferably that parameter is temperature. When a plurality of parameters are detected for the control methods herein, such parameters are preferably temperature and pressure, or pressures at two distinct locations, or pressures at two distinct locations and temperature. Temperature may be measured at any place in the system, but preferably in the reactor.

In one embodiment, the present invention provides a method for controlling hydrogen generation from a fuel solution in a system that comprises a hydrogen generator having a fuel chamber that houses a liquid fuel, a reactor chamber wherein the liquid fuel undergoes at least one reformation reaction to produce hydrogen, and at least one sensor in communication with the reactor chamber, the sensor measuring system parameters of the hydrogen generator. In one embodiment, the system comprises at least two sensors that independently detect at least two system parameters which are selected from the group consisting of a first hydrogen gas pressure; a second hydrogen gas pressure; and a reactor temperature. Preferably, the hydrogen generator of the system of the present invention further comprises a controller which is configured to receive input values from the sensors and which, based on the received input values, controls the flow of the fuel solution to the reactor chamber.

According to another embodiment, the present invention provides a method for monitoring and controlling a hydrogen generator by: (i) providing a hydrogen generator comprising a fuel chamber and a reactor chamber; (ii) detecting at least two system parameters of the hydrogen generator; and (iii) controlling the flow of fuel from the fuel chamber to the reactor chamber based on the detected system parameters.

According to a further embodiment, the present invention provides a method for generating hydrogen by: (i) providing a hydrogen generator comprising a fuel chamber, containing a reformable fuel, and a reactor chamber; (ii) detecting a first hydrogen gas pressure value; (iii) comparing the first hydrogen gas pressure value to a predetermined pressure value to determine a measured pump speed value; (iv) detecting a reactor temperature value; (v) comparing the reactor temperature value to a predetermined reactor temperature value to determine a maximum pump speed value; and (vi) controlling the flow rate of the reformable fuel based on the measured pump speed value and on the maximum pump speed value.

According to yet another embodiment, the invention provides a method for monitoring and controlling a hydrogen generator by: (i) providing a hydrogen generator comprising a fuel chamber with a reformable fuel and a reactor chamber; (ii) detecting a first (or outlet) hydrogen gas pressure value; (iii) detecting a second (or inlet) hydrogen gas pressure value; (iv) comparing the first and second hydrogen gas pressure values to a predetermined pressure value to determine a measured fuel rate value; (v) optionally detecting a reactor temperature value; (vi) comparing the reactor temperature value to a predetermined reactor temperature value to determine a maximum fuel rate value; and (vii) controlling the flow rate of the reformable fuel based on the measured fuel rate value and the maximum fuel rate value.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

FIG. 1 is a schematic illustration of an embodiment of a hydrogen generation system in accordance with the present invention;

FIG. 2 is a flow chart of a sequence of steps for controlling a hydrogen generation system in accordance with the method of the present invention; and

FIG. 3 is a flow chart of an alternate sequence of steps for controlling a hydrogen generation system in accordance with the present invention.

### DETAILED DESCRIPTION OF THE INVENTION

The present invention provides systems and methods for monitoring at least two system parameters (such as, for example, the system temperature and system pressure, or system pressure at two different locations in the system) of a hydrogen generation system to control hydrogen generation from a fuel solution by regulating the flow rate of the fuel solution to a reactor. The system pressure may be a gas pressure, for example, from the hydrogen gas produced, or a fluid pressure, for example, of the fuel flow at the inlet of the reactor or the product flow at the outlet of the reactor.

The control sequence of the present invention is suitable for controlling hydrogen generation from a reformable fuel, wherein contact of a reformable fuel with a reagent in a reaction chamber produces hydrogen. The reaction chamber used with this exemplary embodiment preferably contains a reagent, such as a catalyst metal supported on a substrate, an unsupported metal, acidic solution, transition metal salt solution, or heat, known to promote the reaction of reformable fuels. The preparation of supported catalysts is disclosed, for example, in U.S. Pat. No. 6,534,033 entitled “System for Hydrogen Generation.” These catalysts and reagents can be combined to work together for the production of hydrogen. For example, heat may be used with a supported metal catalyst system.

As used herein, the term “reformable fuel” is defined as any substantially liquid or flowable fuel material that can be converted to hydrogen via a chemical reaction in a reactor, and includes, for example, hydrocarbons, chemical hydrides, and boron hydrides, among other reformable fuels.

During operation of hydrogen generators that use reformable fuels, the fuel may be conveyed from a fuel storage area through a reaction chamber to undergo a reformation reaction to produce hydrogen. A fuel regulator (such as a pump or a valve, for example) is used to modulate the flow of fuel to the reaction chamber. The fuel flow relates to the rate of hydrogen generation. Fuel flow rate for valve-type systems may be controlled, for example, by pulse-width-modulation (PWM) of the valve state (e.g., open or closed). For pump-type systems, the fuel rate may be controlled, for example, by a variable pump speed or PWM control of a fixed speed pump.

For both chemical hydrides and hydrocarbons, the hydrogen and/or any other gaseous products may be separated from the non-hydrogen products in a hydrogen separation region, and the hydrogen gas then fed to a fuel cell unit, for example. For chemical hydride systems, the non-hydrogen products typically comprise a metal product and potentially water vapor. For hydrocarbons, the non-hydrogen products comprise carbon oxides (e.g., CO₂ and CO) and potentially other gases. In the case of hydrocarbons, the resulting hydrogen-rich gaseous stream is typically sent through an additional purification stage before being sent to, for example, a fuel cell unit.

Hydrocarbon fuels include methanol, ethanol, butane, gasoline, and diesel. Hydrocarbons undergo reaction with water to generate hydrogen gas and carbon oxides. Methanol is preferred for such systems in accordance with the present invention. A representative hydrocarbon reformation reaction is provided in Equation (1) for methanol:
CH₃OH+H₂→3 H₂+CO₂ Equation (1)

Chemical hydride fuels include the alkali and alkaline earth metal hydrides. The chemical hydrides react with water to produce hydrogen gas and a metal salt. These metal hydrides may be utilized in mixtures, but are preferably utilized individually.

Examples of suitable alkali and alkaline earth metal hydrides have the general formula MHₙ wherein M is a cation selected from the group consisting of alkali metal cations such as sodium, potassium or lithium and alkaline earth metal cations such as calcium, and n is equal to the charge of the cation, and, without intended limitation, include NaH, LiH, MgH₂, and the like. Solid metal hydrides may be used as a dispersion or emulsion in a nonaqueous solvent, for example, as commercially available mineral oil dispersions, to allow the fuel to be moved by a pump. Such dispersions may include additional dispersants, such as those disclosed in U.S. patent application Serial No. 11/074,360, entitled “Storage, Generation, and Use of Hydrogen,” the disclosure of which is hereby incorporated herein by reference in its entirety.

Boron hydrides as used in the present invention include, for example, boranes, polyhedral boranes, and anions of borohydrides or polyhedral boranes, such as those provided in co-pending U.S. patent application Ser. No. 10/741,199, entitled “Fuel Blends for Hydrogen Generators,” the disclosure of which is hereby incorporated herein by reference in its entirety. The boron hydrides may react with water to produce hydrogen gas and a boron product, or may undergo thermal dehydrogenation. Suitable boron hydrides include, without intended limitation, neutral borane compounds such as decaborane (14) (B₁₀H₁₄); ammonia borane compounds of formula NHₓBH_{y} and NHₓRBH_{y}, wherein x and y are independently selected from 1, 2, 3, or 4 and do not have to be the same, and R is a methyl or ethyl group; borazane (NH₃BH₃); borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, where M is a cation selected from the group consisting of alkali metal cations, alkaline earth metal cations, aluminum cation, zinc cation, and ammonium cation, and n is equal to the charge of the cation. M is preferably sodium, potassium, lithium, or calcium. Many of the boron hydride compounds are water soluble. Aqueous flowable fuel solutions may be prepared as aqueous mixtures which may contain a stabilizer component, such as a metal hydroxide having the general formula M(OH)ₙ, wherein M is a cation selected from the group consisting of alkali metal cations such as sodium, potassium or lithium, alkaline earth metal cations such as calcium, aluminum cation, and ammonium cation, and n is equal to the charge of the cation. Nonaqueous flowable fuels can be prepared as dispersions or emulsions in nonaqueous solvents, for example, as dispersions in mineral oil, or as solutions in, for example, toluene, glymes, or acetonitrile.

In a preferred embodiment, the reformable fuel is a metal borohydride. A process for generating hydrogen from a stabilized metal borohydride solution is disclosed in U.S. Pat. No. 6,534,033, entitled “A System for Hydrogen Generation,” the disclosure of which is incorporated herein by reference in its entirety. Typically, an aqueous solution of a borohydride compound such as sodium borohydride is delivered from a storage tank to a reaction chamber containing a catalyst material, to undergo the reaction of Equation (2):
MBH₄+4 H₂O→MB(OH)₄+4 H₂+heat Equation (2)
where MBH₄ and MB(OH)₄, respectively, represent an alkali metal borohydride and an alkali metal metaborate. The flow of the borohydride fuel to the reaction chamber may be regulated by a fuel regulator such as a pump or a combination of pressure and a valve, as in, for example, co-pending U.S. patent application Ser. No. 09/902,900, entitled “Differential Pressure Driven Borohydride Based Generator;” U.S. patent application Ser. No. 09/900,625, entitled “Portable Hydrogen Generator;” and U.S. patent application Ser. No. 10/359,104, entitled “Hydrogen Gas Generation System,” the disclosures of which are hereby incorporated herein by reference.

One embodiment of a method for controlling hydrogen generators according to the present invention monitors at least two different parameters of the system. These parameters may include pressure measured downstream of the reaction chamber (Sensor A) and a system temperature, preferably the temperature of the reaction chamber (Sensor B). The downstream pressure measured may be, for example, the pressure of the hydrogen gas produced or the fluid pressure of the product stream. In some instances, it is also preferable to monitor the pressure at the input of the reaction chamber (Sensor C). The inlet pressure may be a gas pressure or a fluid pressure of the fuel being fed to the reactor. The pressure or flow rate can be monitored at any location with respect to the reactor, including in the reactor, at the reactor inlet, reactor outlet, upstream of the reactor, or downstream. The inputs from the sensors monitoring these parameters are collected by a controller (such as a microcontroller or a microprocessor) and are used by the controller to regulate the flow rate of the fuel as described herein. In contrast, previous control strategies that allowed hydrogen generators to be automatically run in a simple on/off mode monitored only one variable (typically the system pressure) to control operation of a fuel pump, as described in “A sodium borohydride on-board hydrogen generator for powering fuel cell and internal combustion engine vehicles,” SAE Paper 2001-01-2529, and U.S. patent application Publication Ser. No. 2004/0172943 A1, entitled “Vehicle Hydrogen Fuel System.”

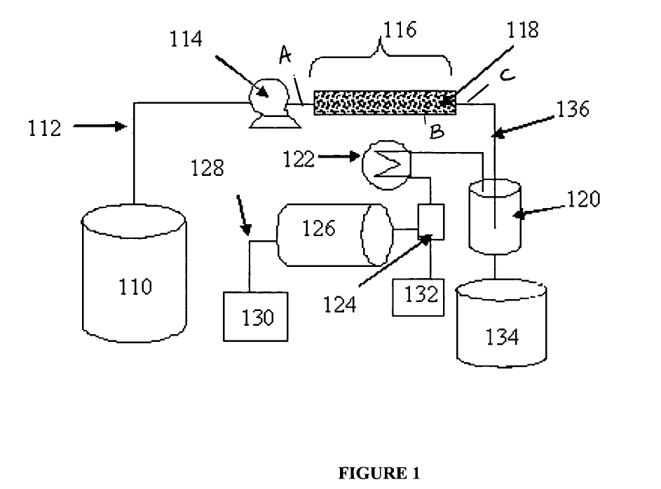

In the present invention, features of control engineering, such as look up tables (LUT), loop algorithms such as Proportional Integral Derivative (PID), and Model Predictive Control, may be used to control hydrogen generation according to the methods described herein. During operation of a hydrogen generation system such as the one illustrated in FIG. 1 controlled by either a pump or a pressure/valve configuration, fuel is metered to the reaction chamber and hydrogen is delivered to an optional hydrogen ballast storage tank. The hydrogen generator may deliver hydrogen to a power module comprising a fuel cell, or to a hydrogen-burning engine for conversion to energy, or to a hydrogen storage device such as a hydrogen cylinder, a reversible metal hydride, or a balloon, for example.

In one embodiment of the present invention, a pressure reading from Sensor A and/or Sensor C is compared by the controller to values in a look up table or a PID set point, to determine the fuel flow rate, valve modulation, or pump speed needed to maintain hydrogen pressure within specified limits. The controller subsequently signals the fuel regulator to deliver fuel to the reaction chamber at the determined rate. As the fuel cell or other downstream mechanism consumes hydrogen gas, pressure Sensors A and/or C detect the resulting pressure change. The rate of the pressure change is dependent on the volume of hydrogen ballast available within the system. That is, at a fixed hydrogen flow output rate, a large hydrogen ballast volume causes the system pressure to drop slower than for a smaller hydrogen ballast volume. This relationship can be determined using standard gas pressure-volume relationships, such as those provided by the ideal gas law, PV=nRT, among other relationships. Pressure measurements are collected as input by the sensors. If the pressure is above the desired level, less fuel is delivered, such as by reducing fuel pump speed. Conversely, if the pressure is below the desired level, more fuel is delivered. In this manner, the hydrogen delivery pressure remains relatively constant.

One significant advantage to controlling hydrogen generation according to methods of the present invention is that it is possible to minimize the hydrogen ballast volume and avoid large system pressure swings. Incorporating minimal volumes for storage of hydrogen ballast results in greater system energy density by reducing overall system volume. The rate of fuel flow to the reaction chamber also is more consistent at steady pressures, and optimizes the conversion efficiency of the reformable fuel to hydrogen.

In another embodiment, monitoring the differential pressure across the reaction chamber (e.g., the pressure difference between Sensor A and Sensor C) either upstream and downstream, or at the inlet and outlet, of the reactor (or combinations of these locations) provides a means to monitor the reaction chamber for clogging from precipitated solids in the product stream. An undetected clog in the reaction chamber could lead to excessive reaction chamber pressure and cause failure of upstream components, possibly resulting in damaged equipment and injury. This method of monitoring the differential pressure over time also provides a means to detect a partial clog before the chamber is completely blocked.

The reliability of hydrogen generation systems is improved by monitoring the system hydrogen pressure. Due to the physical properties of some reformable fuels and, in particular the tendency of liquid borohydride fuels to off-gas, conventional pumps may cavitate and require re-priming. The system pressure is related to the rate of fuel flow though the reaction chamber. Accordingly, if the operating performance of the system does not meet the specified profile as monitored by Sensors A and/or C, the fuel pump can be re-primed by the system.

In a further embodiment, monitoring the reaction chamber temperature via Sensor B provides additional benefits for system control. First, when a hydrogen generator is initially started, the reaction chamber is typically not at its optimum operating temperature, for example, usually between about 50-150° C. for a borohydride fuel or above about 200° C. for hydrocarbon fuels. Sensor B enables the implementation of a distinct startup algorithm which is different from the running algorithm used during operation. Use of a distinct startup algorithm can improve the startup time of the generator and result in higher initial fuel efficiency, as less fuel is fed through the reactor at lower temperatures when the conversion efficiency of the fuel to hydrogen is below about 90%.

As an example, the startup algorithm useful for the exothermic hydrolysis reaction of boron hydrides can meter fuel to the reaction chamber at a slow rate, to allow the chamber to increase in temperature as a result of the exothermic hydrolysis such as illustrated in Equation (2). When the system detects via Sensor B that the reactor has reached the predetermined optimum temperature, the system can switch into a normal running algorithm to maintain the reaction chamber at the operating temperature.

As another example of a startup algorithm useful for the exothermic hydrolysis reaction of the boron hydrides, a predetermined volume of fuel can be pumped to the reaction chamber and held within the chamber in contrast to the flow-through operation described previously. The batch of fuel reacts to generate hydrogen and heat. When the system detects via Sensor B that the reactor has reached the predetermined optimum temperature, the system can switch into a normal running algorithm to maintain the reaction chamber at the operating temperature and resume pumping fuel through the reaction chamber.

Further, the use of Sensor B to monitor the temperature of the reaction chamber during operation allows the controller to detect any problems with the hydrogen generator. If the temperature deviates from the predetermined specified range, the system can be shut down safely. For instance, if the temperature were to drop below the preferred operating temperature range, this may indicate a problem with the reaction chamber such as catalyst degradation, and the system may be shut down and a “service required” signal provided to the operator indicating a need for servicing.

In another embodiment, Sensor B allows the implementation of heat management if necessary for the hydrogen generation system to maintain the reactor within a specified range. For example, to facilitate operation of the hydrogen generation system in a variety of environmental conditions, the reactor can be equipped with elements to heat or cool using, for example, heating elements, heat exchangers, or cooling loops. Sensor B can provide the input needed to control the fuel flow to the reactor. Sensor B also can provide input needed to control the heat management system to achieve efficient system operation. For optimum efficiency and predictability, it is desirable that the fuel be converted to hydrogen at consistent conversion efficiency. Limiting the flow of fuel when the reactor is below the optimum operating temperature prevents fuel from passing through the reactor without being completely converted.

The methods of the present invention for monitoring and controlling the hydrogen generation process based on at least the combination of the Sensors A and B is applicable for use with systems operating at power ranges from milliwatts to megawatts in a variety of applications. While the preceding description refers primarily to stand-alone hydrogen generators, this control strategy can readily be integrated with a fuel cell or other load. This load is strongly correlated to hydrogen demand and can be input to the hydrogen generator control system to provide advanced notice of hydrogen delivery requirements. This ensures that the fuel regulation control element can respond to hydrogen demand in such a manner that the hydrogen pressure is maintained within acceptable limits over a wide range of demand profiles.

The following examples further describe and demonstrate features of the present invention. The examples are given solely for the illustration purposes and are not to be construed as a limitation of the present invention.

### EXAMPLE 1

A hydrogen generation system as shown in FIG. 1 was controlled by a method according to the present invention and used to generate hydrogen for a fuel cell requiring hydrogen delivered at 25 psig and a gas flow rate of about 10 standard liters per minute. Referring to FIG. 1, the borohydride fuel solution is metered from storage tank 110 through fuel line 112 using fuel pump 114 and delivered into reaction chamber 116 comprising catalyst bed 118 where it undergoes the reaction of Equation (1) to generate hydrogen and a borate salt. The product stream is carried to a gas liquid separator 120 via conduit line 136 and the hydrogen gas is processed through a heat exchanger 122 to cool the gas stream to near ambient temperature and a condenser 124 to remove water from the hydrogen gas stream. Condensed water is collected in water tank 132. The hydrogen gas is fed to a ballast tank 126 and then carried through the hydrogen conduit line 128 to feed a fuel cell 130. The liquid borate product stream from the gas-liquid separator 120 is drained to a borate tank 134.

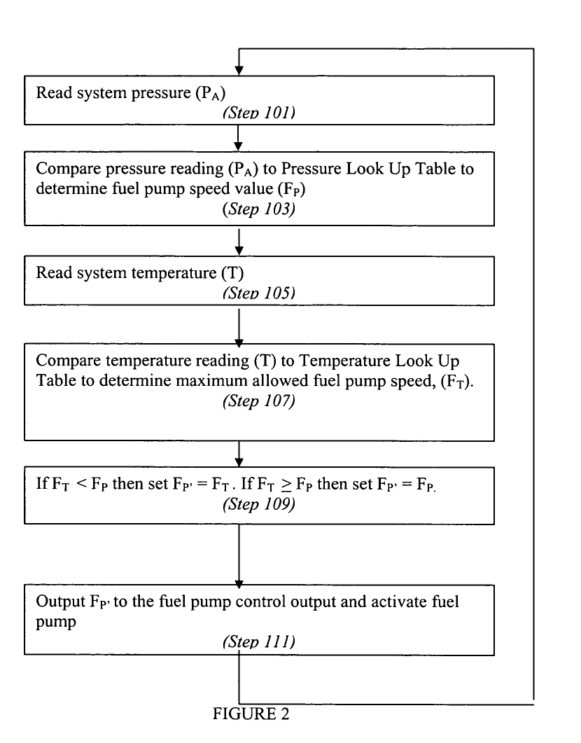

The reaction chamber was equipped with inlet (Sensor A) pressure and temperature (Sensor B) sensors that provided input to a controller element. The system was automatically controlled according to the method illustrated in FIG. 2. The sensor inputs provided the necessary data to control the fuel pump 114 and fuel flow to the reactor. The controller received system pressure (P_{A}) readings at defined intervals in Step 101, which were compared to the Pressure LUT (Table 1A) to determine a flow rate (F_{P}) for the fuel pump in Step 103. The controller also received reactor temperature readings at defined intervals in Step 105, which were compared to the Temperature LUT (Table 1B) to determine a maximum flow rate (F_{T}) for the fuel pump in Step 107.

TABLE 1A
Pressure LUT

| Sensor A Pressure (psig) | FP Pump Flow Rate (mL/min) |
|---|---|
| 0 | 6 |
| 2 | 4 |
| 4 | 2 |
| 6 or greater | 1 |

TABLE 1B
Temperature LUT

| Temperature (° C.) | FT Max Pump Flow Rate (mL/min) |
|---|---|
| 20 | 1 |
| 30 | 2 |
| 40 | 4 |
| 50 or greater | 6 |

The controller compared the two pump rates in Step 109 to limit the pump speed and fuel flow at low temperatures. Thus, if FT<FP, then the controller instructs the fuel pump to deliver fuel at a pump rate FP′=FT. Likewise, if FT>FP, then at a pump rate FP′=FP. Table 2 illustrates pump rates for a series of conditions.

TABLE 2
Pump Rates

| Sensor A Pressure | Temperature | |
|---|---|---|
| (psig) | (° C.) | FP′ Pump Flow Rate (mL/min) |
| 0 | 20 | 1 |
| 2 | 40 | 4 |
| 6 | 40 | 1 |

### EXAMPLE 2

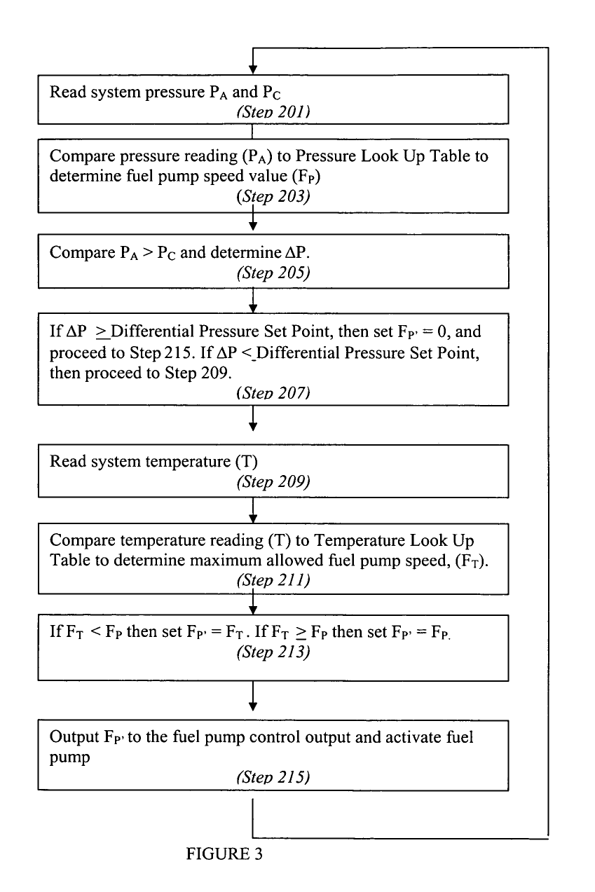

The reaction chamber of the system described in Example 1 was equipped with inlet (Sensor A) and outlet (Sensor C) pressure and temperature (Sensor B) sensors that provided input to a controller element. The system was automatically controlled according to the method illustrated in FIG. 3. The controller received system pressure (P_{A} and P_{C}) readings at defined intervals in Step 201. The P_{A} readings were compared to the Pressure LUT (Table 1A) to determine a flow rate (F_{P}) for the fuel pump in Step 203. The difference in pressure determined in Step 205 was compared to a set point in Step 207. If the pressure exceeded the set point, the fuel pump was immediately signaled to stop feeding fuel to the reactor. If the pressure difference was below the set point, the controller determined the fuel flow by the comparison of fuel flow rates determined by the temperature and pressure lookup tables as described in Example 1 (Steps 209 to 215) to determine the maximum flow rate (F_{P′}) for the fuel pump.

During normal operation of this system, the inlet pressure is typically 3 to 8 psi greater than the outlet pressure due to the liquid flow characteristics of the reactor. The pressure set point was set at 15 psig and the controller element programmed to detect any pressure difference across the reactor (between Sensors A and C) exceeding this set point. During a test run, the reactor became partially clogged, stopping normal fuel flow. The controller element detected the abnormal pressure difference and instructed fuel pump 114 to halt additional fuel flow, ceasing hydrogen production before dangerous pressure levels could develop in the system.

While the present invention has been described with respect to particular disclosed embodiments, it should be understood that numerous other embodiments are within the scope of the present invention. For example, the pump rates in the examples are illustrative of the particular systems described and can be greater or lower than these values for any system depending on, such as, the hydrogen pressures and flow rates required by the fuel cell power module or other load. Such values may be readily ascertained by one skilled in the art given the teachings herein and can be directly correlated to the specific regulating mechanism of each system, be it via for example pump speed, valve modulation, fuel line pressure, or a combination of these or other mechanisms having a cause and effect relationship with fuel flow to and/or through a reactor. Similarly, other values to shut off the fuel pump (e.g., set the pump rate to zero) can be incorporated into the control strategy for various desired maximum operating temperatures and/or pressures.

What is claimed as new and desired to be protected by Letters Patent of the United States is:

1. A method for controlling hydrogen generation in a hydrogen generating system having a fuel chamber containing a fuel, and a reactor, comprising:
detecting at least one system parameter; and
controlling the flow of the fuel from the fuel chamber to the reactor based on the detected at least one system parameter,
wherein the at least one system parameter is system temperature, or at least two system parameters selected from the group consisting of a first pressure measured at a first location with respect to the reactor, a second pressure measured at a second location with respect to the reactor, and a |temperature within the system.|

2. The |Method of claim 1, wherein the at least one parameter is temperature.|

3. The method of claim 1 further comprising detecting a pressure at a location with respect to the reactor and detecting a temperature within the system.

4. The method of claim 1 further comprising detecting a first pressure at a first location with respect to the reactor and detecting a second pressure at a second location with respect to the reactor.

5. The method of claim 2 wherein the temperature is a temperature of the reactor.

6. The method of claim 1 further comprising:

|detecting a first pressure at a| first location with respect to the reactor;
comparing the first pressure to a predetermined pressure to determine a first fuel rate value;

|detecting a temperature within the system;|

comparing the temperature to a predetermined temperature to determine a maximum fuel rate value;
comparing the first fuel rate value to the maximum fuel rate value to determine a system output value; and
controlling the flow rate of the fuel to the reactor based on the system output value.

7. The method of claim 6, wherein the temperature is a reactor temperature.

8. The method of claim 6, wherein the first pressure is hydrogen gas pressure.

9. The method of claim 6, wherein the first pressure is fluid pressure of the fuel at a location between the fuel chamber and the reactor.

10. The method of claim 6, wherein the first pressure is product pressure of a product at a location downstream of the reactor.

11. The method of claim 6 further comprising:
detecting a second pressure at a second location of the reactor;
comparing each of the first and second pressures to determine a first pressure differential;
comparing the first pressure differential to a predetermined pressure differential; and
interrupting the flow of fuel to the reactor if the first pressure differential is greater than the predetermined pressure differential.

12. The method of claim 6 further comprising:
providing at least one sensor adjacent the reactor to measure the at least one system parameter;
providing a controller for receiving input values from the at least one sensor;
providing an output value based on the input values; and
controlling the flow of the fuel based on the output value.

13. The method of claim 6, wherein determining the system output value comprises setting the system output value to the maximum fuel rate value if the maximum fuel rate value is less than the first fuel rate value.

14. The method of claim 13, wherein determining the system output value comprises setting the system output value to the first fuel rate value if the maximum fuel rate value is equal to or greater than the first fuel rate value.

15. The method of claim 14, further comprising periodically monitoring the at least one system parameter and resetting the system output value.

16. The method of claim 1, wherein the fuel is a reformable fuel.

17. The method of claim 1, wherein the hydrogen generating system is connected to a fuel cell.

18. A method of generating hydrogen, comprising:
providing a hydrogen generator having a fuel chamber for containing a fuel, a reactor, and a pump for conveying fuel to the reactor;
providing at least two sensors to independently measure at least two system parameters of the hydrogen generator;
providing a controller for receiving input values from the at least two sensors and for providing an output value based on the input values; and
controlling the pump speed based on the output value.

19. The method of claim 18, wherein one of the at least two system parameters is hydrogen gas pressure and another of the at least two system parameters is reactor temperature.

20. The method of claim 18, wherein the fuel is a reformable fuel.

21. The method of claim 18, wherein the fuel is selected from the group consisting of chemical hydrides and hydrocarbons.

22. The method of claim 18, wherein the fuel is a boron hydride.

23. The method of claim 18 further comprising:
measuring a first hydrogen gas pressure at a first location of the reactor;
comparing the first hydrogen gas pressure to a predetermined pressure to determine a first pump speed value;
detecting a first reactor temperature;
comparing the first reactor temperature to a predetermined temperature to determine a maximum pump speed value;
comparing the first pump speed value to the maximum pump speed value to determine a system output value; and
setting the pump speed based on the system output value.

24. The method of claim 23, wherein determining the system output value comprises setting the system output value to the maximum pump speed if the maximum pump speed is less than the first pump speed.

25. The method of claim 24, wherein determining the system output value comprises setting the system output value to the first pump speed if the maximum pump speed is equal to or greater than the first pump speed.

26. The method of claim 23, further comprising periodically monitoring the system parameters and resetting the system output value.

27. The method of claim 23 further comprising:
measuring a second hydrogen gas pressure at a second location of the reactor;
comparing each of the first and second hydrogen gas pressures determine a first pressure differential;
comparing the first pressure differential to a predetermined pressure differential, and setting the pump speed to zero if the first pressure differential is greater than the predetermined pressure differential.

28. The method of claim 18, wherein the pump is modulated via PWM modulation of a fixed speed pump.

29. A hydrogen generator, comprising:
a fuel storage chamber for a fuel solution;
a fuel regulating means for conveying at least part of the fuel solution from the fuel storage chamber to a reactor chamber;
at least two sensors configured to sense at least two system parameters, wherein the at least two system parameters are |independently selected from the group consisting of a first pressure measured at a first location with respect to the reactor, a second pressure measured at a second location with respect to the reactor;|and a temperature within the system; and
a controller in communication with the at least two sensors and with the fuel regulating means.

30. The hydrogen generator of claim 29, wherein one of the first pressure and the second pressure is hydrogen gas pressure.

31. The hydrogen generator of claim 29, wherein one of the first pressure and the second pressure is fluid pressure.

32. The hydrogen generator of claim 29, wherein the fuel regulating means comprises a fuel pump.

33. The hydrogen generator of claim 29, wherein the fuel regulating means comprises a valve.

34. The hydrogen generator of claim 29, wherein the at least two sensors detect at least two different system parameters.

35. The hydrogen generator of claim 29, wherein at least one of the system parameters is hydrogen gas pressure.

36. The hydrogen generator of claim 29, wherein at least one of the system parameters is reactor chamber temperature.

37. The hydrogen generator of claim 29, wherein the controller is a microcontroller or a microprocessor.

38. The hydrogen generator of claim 29, wherein the fuel solution is a reformable fuel.

39. The hydrogen generator of claim 29, wherein the fuel solution comprises fuel selected from the group consisting of chemical hydrides and hydrocarbons.

40. The hydrogen generator of claim 29, wherein the fuel solution is a metal borohydride.

41. The hydrogen generator of claim 29, wherein the reactor chamber further comprises a reagent.

42. The hydrogen generator of claim 41, wherein the reagent is selected from the group consisting of a supported catalyst, an acidic solution, a transition metal salt solution and heat.

43. The hydrogen generator of claim 29, wherein hydrogen from the reactor chamber is delivered to a power module.

44. The hydrogen generator of claim 43, wherein the power module comprises a fuel cell.

45. The hydrogen generator of claim 29, wherein the controller is configured to compare a first pressure to a predetermined pressure to determine a first fuel rate value;
compare the reactor temperature to a predetermined temperature to determine a maximum fuel rate value;
compare the first fuel rate to the maximum fuel rate value to determine a system output value; and
control the flow rate of the fuel to the reactor based on the system output value.

46. The hydrogen generator of claim 45, wherein the controller is configured to compare each of a first and second pressure to determine a first pressure differential;
compare the first pressure differential to a predetermined pressure differential; and
interrupt the flow of fuel to the reactor if the first pressure differential is greater than the predetermined pressure differential.

47. The hydrogen generator of claim 46, wherein the controller is configured to set the system output value to the maximum fuel rate if the maximum fuel rate is less than the first fuel rate.

48. The hydrogen generator of claim 47, wherein the controller is configured to set the system output value to the first fuel rate if the maximum fuel rate is equal or greater to the first fuel rate.

49. The hydrogen generator of claim 47, wherein the controller is configured to periodically monitor the system parameters and reset the system output value.

50. The hydrogen generator of claim 29, wherein the fuel regulating means comprises a pump and the system output value is pump speed.

51. A method of generating hydrogen, comprising:
providing a hydrogen generator having a fuel chamber for containing a fuel, a reactor, and a valve for controlling flow of fuel to the reactor;
providing at least two sensors to independently measure at least two system parameters of the hydrogen generator;
providing a controller for receiving input values from the at least two sensors and for providing an output value based on the input values; and
controlling the valve speed based on the output value.

52. The method of claim 51, wherein one of the at least two system parameters is hydrogen gas pressure and another of the at least two system parameters is reactor temperature.

53. The method of claim 51, wherein the fuel is a reformable fuel.

54. The method of claim 51, wherein the fuel is selected from the group consisting of chemical hydrides and hydrocarbons.

55. The method of claim 51, wherein the fuel is a boron hydride.

56. The method of claim 51 further comprising:
measuring a first hydrogen gas pressure at a first location of the reactor;
comparing the first hydrogen gas pressure to a predetermined pressure to determine a first valve speed value;
detecting a first reactor temperature;
comparing the first reactor temperature to a predetermined temperature to determine a maximum valve speed value;
comparing the first valve speed value to the maximum valve speed value to determine a system output value; and
setting the valve speed of the system based on the system output value.

57. The method of claim 56, wherein determining a system output value comprises setting the system output value to the maximum valve speed if the maximum valve speed is less than the first valve speed.

58. The method of claim 57, wherein determining a system output value comprises setting the system output value to the first valve speed if the maximum valve speed is equal to or greater than the first valve speed.

59. The method of claim 56, further comprising periodically monitoring the system parameters and resetting the system output value.

60. The method of claim 56 further comprising:
measuring a second hydrogen gas pressure at a second location of the reactor;
comparing each of the first and second hydrogen gas pressures determine a first pressure differential;
comparing the first pressure differential to a predetermined pressure differential, and setting the valve speed to zero if the first pressure differential is greater than the predetermined pressure differential.
